(19) United States
(12) Patent Application Publication
(10) Pub. No.: US 2022/0199057 A1
(43) Pub. Date: Jun. 23, 2022

(54) Sound Signal Generation Method, Sound Signal Generation Device, Non-transitory Computer Readable Medium Storing Sound Signal Generation Program and Electronic Musical Apparatus

(71) Applicant: Yamaha Corporation, Hamamatsu-shi (JP)

(72) Inventors: Masafumi NAKATA, Hamamatsu-shi (JP); Naoaki IWANAGA, Toyokawa-shi (JP)

(21) Appl. No.: 17/693,059

(22) Filed: Mar. 11, 2022

Related U.S. Application Data
(63) Continuation of application No. PCT/JP2020/033505, filed on Sep. 3, 2020.

(30) Foreign Application Priority Data
Sep. 12, 2019 (JP) 2019-166404

(51) Int. Cl. G10H 1/14; G10H 1/46; G10H 1/00; G10H 1/34; G10H 5/02

(52) U.S. Cl. CPC G10H 1/14; G10H 1/46; G10H 1/0008; G10H 2210/295; G10H 5/02; G10H 2220/221; G10H 1/344

(57) ABSTRACT

A sound signal generation method includes receiving a pitch and an intensity, and generating a sound signal corresponding to the pitch such that a size of a sound image of the sound signal is adjusted in accordance with the intensity.

### BACKGROUND

### Technical Field

The present disclosure relates to a sound signal generation method, a sound signal generation device, a non-transitory computer readable medium storing a sound signal generation program and an electronic musical apparatus including the sound signal generation device.

### Description of Related Art

When a player depresses a key of an acoustic piano, a string corresponding to the key vibrates. The string is connected to a bridge arranged on a soundboard. When the string vibrates, the soundboard vibrates due to transmission of vibration of the string via the bridge. Thus, in the acoustic piano, a sound is generated from the soundboard together with a vibration sound of the string in accordance with a key depressing operation performed by the player.

Vibration of the soundboard depends on an operation intensity of key depression by the player. When the player depresses a key strongly, the soundboard vibrates strongly, and a wide sound is generated. When the player presses a key gently, the soundboard vibrates weakly, and a less wide sound is generated.

In an electronic keyboard musical instrument, a string or a soundboard is not present. Therefore, a sound signal of a pitch corresponding to a depressed key is output from a tone generator. A sound signal output from the tone generator is converted into an analogue signal and then output from a speaker. The below-mentioned JP 2015-079121 A discloses a technique for dividing a sound emitted from the tone generator into partial signals and synthesizing the plurality of partial signals for playback.

### SUMMARY

A player who plays an electronic keyboard musical instrument desires a higher level of musical performance as he or she masters a skill. It is an important element for a player to generate a performance sound similar to that of an acoustic piano in providing a high level musical performance.

An object of the present disclosure is to provide a sound signal generation method, a sound signal generation device, a non-transitory computer readable medium storing a sound signal generation program and an electronic musical apparatus that enables generation of a musical performance sound similar to that of an acoustic piano.

A sound signal generation method according to one aspect of the present disclosure includes receiving designation of a pitch and an intensity, and generating a sound signal corresponding to a received pitch such that a size of its sound image is in accordance with a received intensity.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a block diagram showing the configuration of an electronic musical apparatus including a sound signal generation device according to embodiments of the present disclosure.

FIG. 2 is a block diagram showing the configuration of the sound signal generation device and its peripheral devices according to the embodiments.

FIG. 3 is a block diagram showing the configuration of a tone generator according to a first embodiment.

FIG. 4 is a diagram showing nodes included in a sound image adjuster and the circuit between nodes according to the first embodiment.

FIG. 5 is a diagram showing an outputter of the sound image adjuster according to the first embodiment.

FIG. 6 is a block diagram showing the configuration of a tone generator according to a second embodiment.

FIG. 7 is a block diagram showing the configuration of a tone generator according to a third embodiment.

FIG. 8 is a block diagram showing the configuration of a tone generator according to a fourth embodiment.

FIG. 9 is a block diagram showing the configuration of a sound signal generation device and its peripheral devices according to a fifth embodiment.

FIG. 10 is a flowchart showing a sound signal generation method performed in the sound signal generation device according to the fifth embodiment.

### DETAILED DESCRIPTION

A sound signal generation method, a sound signal generation device, a non-transitory computer readable medium storing a sound signal generation program and an electronic musical apparatus according to embodiments of the present disclosure will be described below in detail with reference to drawings.

### [1] First Embodiment

(1) Sound Image

A change of a sound image which is an object of the present disclosure will be described prior to the description of embodiments. A sound image is localization of a sound. That is, a sound image means that a sound is heard as if its tone generator is where it is to be. A sound having a large sound image means a wide sound, a sound having a strong reverb effect, a sound having a large left-right phase difference or a sound having a large variation range in regard to the left-right localization of a sound, for example. Further, when a sound is heard from two tone generators that are spaced apart from each other, a listener can obtain a sense of depth in the sound. For example, with a grand piano (acoustic piano), a sound is heard as if a tone generator is near a bridge on a soundboard. With a grand piano, a player can feel a sense of depth in a musical performance sound by listening to a sound generated from a tone generator located near a bridge close to the player and a sound generated from a tone generator located near a bridge far from the player. An object of the present disclosure is to generate a sound signal the sound image of which changes similarly to an acoustic piano in an electronic musical apparatus without a string or a soundboard. In other words, an object of the present disclosure is to provide a performance feeling similar to that of an acoustic piano to a player by expressing a wide sound (sound with a sense of depth) and a less wide sound in an electronic musical apparatus.

(2) Configuration of Electronic Musical Apparatus

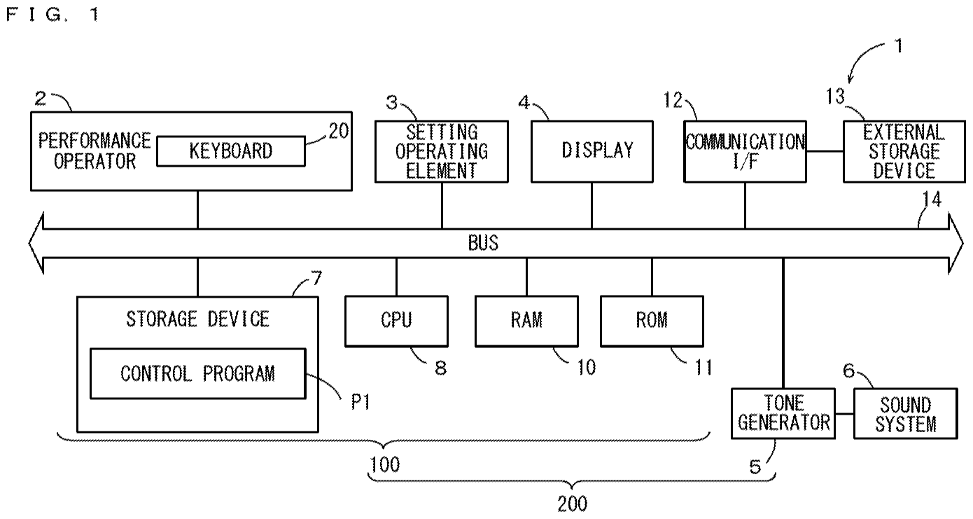

FIG. 1 is a block diagram showing the configuration of the electronic musical apparatus 1 including the sound signal generation device 200 according to a first embodiment of the present disclosure. Since being a device that electronically generates a sound, the electronic musical apparatus 1 including the sound signal generation device 200 of the first embodiment does not have a string or a soundboard. An object of the electronic musical apparatus 1 including the sound signal generation device 200 of the present embodiment is to provide a performance feeling similar to that of an acoustic piano to a player by artificially changing a sound image of a sound generated in accordance with an intensity of a key depressing operation.

The electronic musical apparatus 1 of FIG. 1 is an electronic keyboard musical instrument, for example. The electronic musical apparatus 1 comprises a performance operator 2, setting operating elements 3 and a display 4. In the present embodiment, the performance operator 2 includes a keyboard 20 and is connected to a bus 14. The keyboard 20 has a plurality of keys arranged in a row. In the present embodiment, the keyboard 20 includes 88 keys. However, the number of keys included in the keyboard 20 is not limited to this. The keyboard 20 of the performance operator 2 may be an image of a keyboard displayed on a screen of a touch panel display mentioned below.

The setting operating elements 3 include operation switches that are operated in an on-off manner, operation switches that are operated in a rotational manner or operation switches that are operated in a sliding manner, etc. and are connected to the bus 14. The setting operating elements 3 are used for various settings including adjustment of the volume and on-off of a power supply. The display 4 includes a liquid crystal display, for example, and is connected to the bus 14. A name of a musical piece, a music score or other various information is displayed on the display 4. The display 4 may be a touch panel display. In this case, part or all of the performance operator 2 or the setting operating elements 3 may be displayed on the display 4. The player can provide instructions for various operations by operating the display 4.

The electronic musical apparatus 1 includes a tone generator 5 and a sound system 6. The tone generator 5 is connected to the bus 14 and outputs audio data (audio signals) based on the pitch designated by an operation using the performance operator 2. Audio data is sampling data (PCM (Pulse Code Modulation) data, for example) showing the waveform of a sound.

Hereinafter, audio data output by the tone generator 5 is referred to as a sound signal. The tone generator 5 stores sound signals of all pitches in advance. Further, the tone generator 5 includes a function of adjusting a sound image, as described below. The sound system 6 includes a digital-analogue (D/A) conversion circuit, an amplifier and a speaker. The sound system 6 converts a sound signal supplied from the tone generator 5 into an analogue sound signal and generates a sound based on the analogue sound signal. The sound system 6 is an example of an outputter in the present disclosure.

The electronic musical apparatus 1 further comprises a storage device 7, a CPU (Central Processing Unit) 8, a RAM (Random Access Memory) 10, a ROM (Read Only Memory) 11 and a communication I/F (Interface) 12. The storage device 7, the CPU 8, the RAM 10, the ROM 11 and the communication I/F 12 are connected to the bus 14. An external apparatus such as an external storage device 13 may be connected to the bus 14 via the communication I/F 12.

The storage device 7 includes a storage media such as a hard disc, an optical disc, a magnetic disc or a memory card. A computer program such as a control program P1 is stored in the storage device 7.

The RAM 10 is a volatile memory, for example, which is used as a working area for the CPU 8, and temporarily stores various data. The ROM 11 is a nonvolatile memory, for example. The storage device 7, the CPU 8, the RAM 10 and the ROM 11 constitute a controller 100. The controller 100 and the tone generator 5 constitute the sound signal generation device 200.

(3) Functional Configuration of Sound Signal Generation Device 200

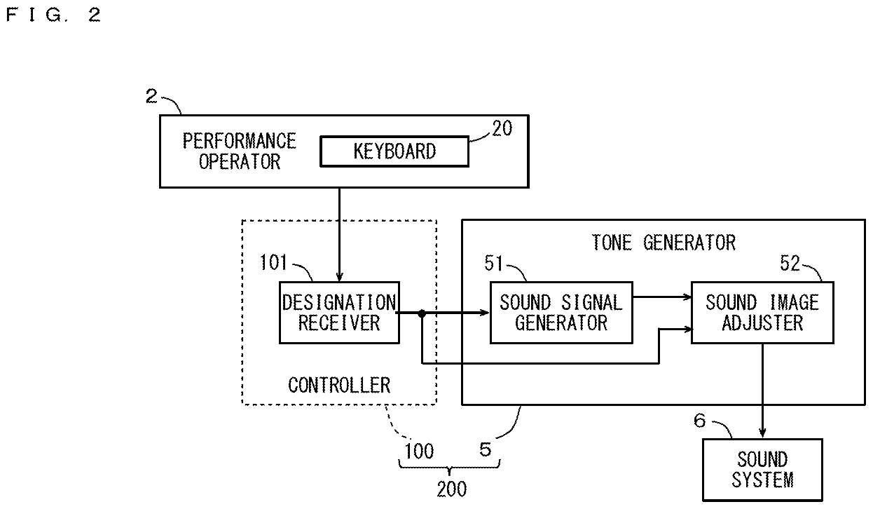

FIG. 2 is a block diagram showing the functional configuration of the sound signal generation device 200 and its peripheral devices. As shown in FIG. 2, the controller 100 includes a designation receiver 101. The designation receiver 101 is implemented when the CPU 8 of FIG. 1 executes the control program P1 stored in the storage device 7 while using the RAM 10 as a work area.

When the player depresses a key of the keyboard 20, a note-on event (hereinafter abbreviated as a note-on) including the pitch corresponding to the depressed key is generated. A note-on is equivalent to a state transition of a key from an OFF state to an ON state. Further, when the player releases a key of the keyboard 20, a note-off event (hereinafter abbreviated as a note-off) including the pitch corresponding to the released key is generated. A note-off is equivalent to a state transition of a key from an ON state to an OFF state.

The designation receiver 101 receives operation information of a key included in the keyboard 20. The operation information of a key includes information relating to a pitch, a note-on, a note-off and an operation intensity of the key. The performance operator 2 acquires an operation intensity of a key by detecting a key-depression speed using a sensor provided in each key of the keyboard 20, for example. The designation receiver 101 supplies the received operation information to the tone generator 5. An operation intensity of the present embodiment is an example of an “intensity” of the present disclosure.

The tone generator 5 includes a sound signal generator 51 and a sound image adjuster 52. The sound signal generator 51 outputs a sound signal corresponding to a received pitch based on operation information supplied from the designation receiver 101. In a case in which the operation information represents a note-on of any pitch, the sound signal generator 51 outputs a sound signal of the pitch represented by the received note-on. In a case in which the operation information represents a note-off of any pitch, the sound signal generator 51 stops the output of a sound signal of the pitch represented by the received note-off. Further, the sound signal generator 51 adjusts the level of a sound signal of a pitch represented by a note-on in accordance with an operation intensity included in the operation information. In a case in which a key is depressed strongly by the player, the level of an output sound signal is high. In a case in which a key is depressed gently by the player, the level of an output sound signal is low.

The sound image adjuster 52 receives a sound signal output by the sound signal generator 51. The sound image adjuster 52 adjusts a sound image of the sound signal in accordance with an operation intensity included in the operation information. The sound signal, having the adjusted sound image, that is output from the sound image adjuster 52 is supplied to the sound system 6. The sound system 6 outputs a sound having a sound image the size of which is in accordance with the operation intensity of key depression.

(4) Configuration of Tone Generator

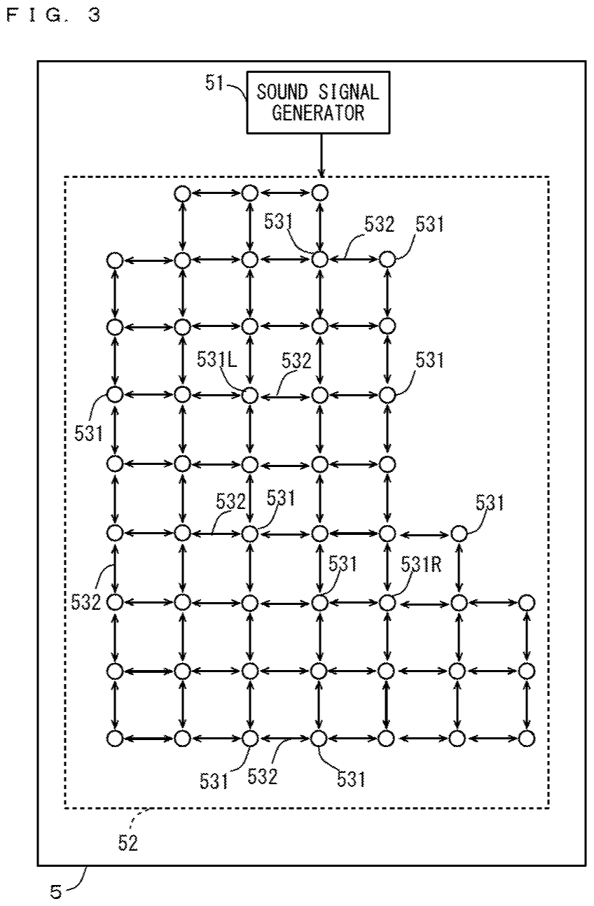

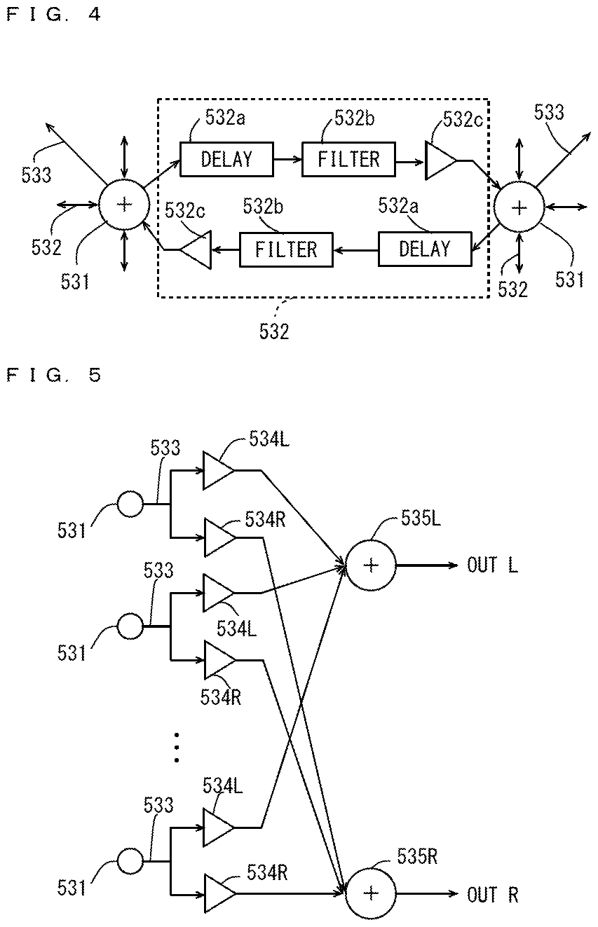

Next, the configuration of the tone generator 5 according to the first embodiment will be described. FIG. 3 is a diagram showing the configuration of the tone generator 5 according to the first embodiment. FIG. 4 is a diagram showing nodes included in the sound image adjuster 52 and the circuit between the nodes. FIG. 5 is a diagram showing an outputter of the sound image adjuster 52.

As shown in FIG. 3, the sound image adjuster 52 includes a transmission network constituted by a plurality of nodes 531 that are connected to one another by in-between nodes transmission circuits 532. The nodes 531 are arranged on a grid. Nodes 531 that are adjacent to each other in a longitudinal direction is connected to each other by an in-between nodes transmission circuit 532, and nodes 531 that are adjacent to each other in a transverse direction are connected to each other by an in-between nodes transmission circuit 532. An in-between nodes transmission circuit 532 is an example of a “transmission circuit” of the present disclosure. The shape of the transmission network is not limited in particular. It is possible to adjust the size of a sound image that can be created by the tone generator 5 by changing the shape of the transmission network. In the present embodiment, as shown in FIG. 3, the transmission network has a shape imitating a soundboard of an acoustic piano.

As shown in FIG. 4, a node 531 includes a summing element. A node 531 receives sound signals transmitted in the longitudinal direction and the transverse direction from nodes 531 via in-between nodes transmission circuits 532 and sums the sound signals.

An in-between nodes transmission circuit 532 includes delays 532a, filters 532b and amplifying circuits 532c. A sound signal output from one node 531 is delayed in a delay 532a. A predetermined filtering process is performed on a sound signal output from a delay 532a in a filter 532b. For example, a filtering process of removing a high frequency component is performed. Alternatively, a filtering process of adjusting a phase is performed. In regard to a sound signal output from a filter 532b, a gain is adjusted to attenuate the sound signal in an amplifying circuit 532c. In this manner, a sound signal that is output from one node 531 and transmitted to an adjacent node 531 is delayed in a delay 532a and attenuated in an amplifying circuit 532c. Further, in a case in which a filter for removing a high frequency component is used in a filter 532b, the high frequency component is further attenuated.

In this manner, a sound signal output from one node 531 is output to an adjacent node 531 via an in-between nodes transmission circuit 532. Each node 531 sums sound signals received from adjacent nodes 531. A node 531 outputs the sum of the sound signals to an output circuit 533. Further, a node 531 outputs the sum of the sound signals to an in-between nodes transmission circuit 532 different from an in-between nodes transmission circuit 532 via which a sound signal has been transmitted. That is, each node 531 relays a sound signal received from one node 531 to another node 531 without returning the sound signal to the node 531 from which the sound signal has been received such that the sound signal transmitted between nodes does not loop.

Reference is made to FIG. 3 again. In FIG. 3, nodes 531L, 531R are nodes that receive sound signals. A sound signal received from the sound signal generator 51 is input to one of the nodes 531L, 531R. In the present embodiment, to which one of the nodes 531L, 531R a sound signal is to be input is determined based on a pitch received by the designation receiver 101. For example, in a case in which a pitch corresponding to any key out of 44 keys in a lower range out of 88 keys is designated, a sound signal received from the sound signal generator 51 is input to the node 531L. Further, in a case in which a pitch corresponding to any key out of the 44 keys in a higher range is designated, a sound signal received from the sound signal generator 51 is input to the node 531R.

A sound signal input to the node 531L or the node 531R is transmitted in the longitudinal direction and the transverse direction in the transmission network shown in FIG. 3. Then, as described above, each node 531 sums sound signals that are received from adjacent nodes 31 to output the sum of the sound signals. At this time, a delay amount and an attenuation amount of a sound signal transmitted via an in-between nodes transmission circuit 532 increase as the sound signal moves away from the node 531L or 531R to which the sound signal is input. Therefore, in a case in which the level of a sound signal input to the node 531L or the node 531R is high, the sound signal is transmitted to a node 531 distanced from the node 531L or the node 531R. That is, the higher the level of a sound signal is, the larger the range of nodes 531 from which the sound signal is output is. Thus, the higher the level of a sound signal is, the wider a sound is, that is, the larger a sound image of the output sound signal is. In a case in which the level of a sound signal input to the node 531L or the node 531R is small, the sound signal is transmitted to only nodes 531 that are close to the node 531L or the node 531R. That is, the lower the level of a sound signal is, the smaller the range of nodes 531 from which the sound signal is output is. Thus, the lower the level of a sound signal is, the less wide a sound is, that is, the smaller a sound image of the output sound signal is. In this manner, suppose that the nodes 531L, 531R are the bridges attached to a soundboard of an acoustic piano, a sound is transmitted between nodes as a sound spreads on the sound board via the bridges.

As shown in FIG. 5, a sound signal output from an output circuit 533 of each node 531 branches into two directions and is input to respective amplifying circuits 534L, 534R. An amplifying circuit 534L adjusts a gain of a sound signal of a left stereo sound, and an amplifying circuit 534R adjusts a gain of a sound signal of a right stereo sound. Sound signals output from all of the amplifying circuits 534L are summed in a summing element 535L and output as a sound signal of a left stereo sound. Sound signals output from all of the amplifying circuits 534R are summed in a summing element 535R and output as a sound signal of a right stereo sound.

As described above, the sound signal generation device 200 according to the first embodiment adjusts the size of a sound image in accordance with the level of a sound signal. That is, the size of a sound image is adjusted in accordance with an operation intensity included in the operation information. In a case in which the player is pressing a key strongly, a wider sound, that is, a sound having a large sound image is output. In a case in which the player is pressing a key gently, a less wide sound, that is, a sound having a small sound image is output. Thus, the sound signal generation device 200 according to the first embodiment can artificially generate a musical performance sound transmitted to a soundboard of an acoustic piano.

In the sound signal generation device 200 according to the first embodiment, in a case in which an operation intensity included in operation information is high, a sound signal is transmitted to nodes 531 in a larger range in the sound image adjuster 52. In a case in which an operation intensity included in operation information is low, a sound signal is transmitted to nodes 531 in a small range in the sound image adjuster 52. In this manner, in the sound signal generation device 200, a sound signal is generated such that the higher the intensity of a received operation designating a pitch is, the larger the distribution of sound in a distance perspective (the size of a sound image) is.

(5) Effects of First Embodiment

As described above, in the sound signal generation device 200 of the first embodiment, the tone generator 5 generates a sound signal corresponding to a pitch received by the designation receiver 101 such that the size of its sound image is in accordance with an operation intensity received by the designation receiver 101. Thus, the sound signal generation device 200 of the present embodiment can generate a sound signal while changing a sound image in accordance with a received intensity similarly to an acoustic piano.

Further, in the sound signal generation device 200 of the first embodiment, the range of nodes 531 to which a sound signal is transmitted changes in accordance with an operation intensity received by the designation receiver 101. That is, a sound signal is generated such that the higher a received operation intensity is, the larger the distribution of a sound in the distance perspective is. Thus, the sound signal generation device 200 of the present embodiment can provide a performance feeling similar to a performance feeling provided by an acoustic piano to the player.

### [2] Second Embodiment

Next, an electronic musical apparatus 1 including a sound signal generation device 200 according to a second embodiment of the present disclosure will be described. The configuration of the electronic musical apparatus 1 according to the second embodiment is similar to that of the first embodiment shown in FIGS. 1 and 2. In the second embodiment, the configuration of a sound image adjuster 52 is different from that of the first embodiment.

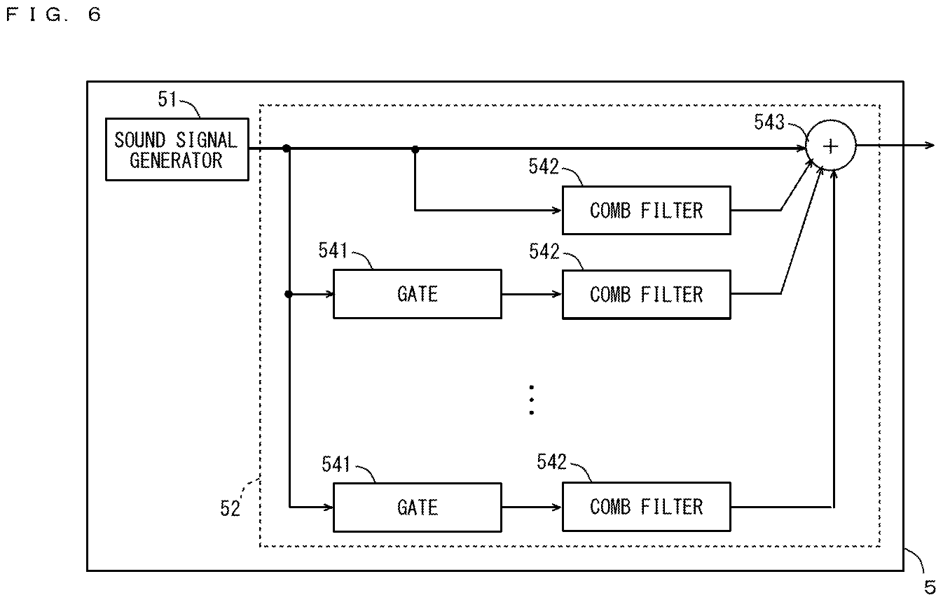

FIG. 6 is a diagram showing the configuration of a tone generator 5 according to the second embodiment. Similarly to the first embodiment, in the tone generator 5, a sound signal output from a sound signal generator 51 is processed in the sound image adjuster 52. The sound image adjuster 52 includes a plurality of gates 541, a plurality of comb filters and a summing element 543.

A sound signal output from the sound signal generator 51 is input to the summing element 543 and the plurality of gates 541. A control signal is supplied to each gate 541 by the control of a controller 100. Each gate 541 is controlled to be opened and closed based on a control signal. A comb filter 542 is connected to a position farther rearward than each gate 541. Further, a comb filter 542 (the comb filter 542 at the top in FIG. 6) to which a sound signal output from the sound signal generator 51 is directly input is provided. A comb filter 542 is a filter that multiplies a delay signal by a gain smaller than 1 and adds the obtained delay signal to an input signal. Since a comb filter 542 repeatedly outputs a signal in a certain period while an input signal is attenuated, a reverb effect (reverberation effect) can be provided to an input sound signal.

With the above-mentioned configuration and the control of the controller 100, a control signal is supplied to each gate 541, and each gate 541 is controlled to be opened and closed. The controller 100 determines the number of gates 541 to be controlled to be opened in accordance with an operation intensity included in operation information. Specifically, the higher an operation intensity of key depression is, the larger the number of gates 541 controlled to be opened is. A gate 541 that is controlled to be opened based on a control signal outputs a sound signal to a comb filter 542 located at a position farther rearward than the gate 541. A gate 541 that is controlled to be closed based on a control signal does not output a sound signal to a comb filter 542 located at a position farther rearward than the gate 541. A comb filter 542 to which a sound signal is input performs the above-mentioned filter process on the sound signal and outputs a sound signal on which the filter process has been performed to a summing element 543.

A summing element 543 sums a sound signal (direct signal) output from the sound signal generator 51, a sound signal output from the comb filter 542 at the top and a sound signal output from a comb filter located at a position farther rearward than the gate 541 that is controlled to be opened. A sound signal output from the summing element 543 is output to the sound system 6.

In this manner, the tone generator 5 according to the second embodiment adjusts the number of enabled comb filters 542 in accordance with an operation intensity included in operation information. Thus, in a case in which an operation intensity of key depression is high, the number of enabled comb filters is increased, and more reverb effect is provided. That is, in a case in which an operation intensity of key depression is high, the tone generator 5 can output a sound signal having a large sound image. In a case in which an operation intensity of key depression is low, the number of enabled comb filters 542 is decreased, and the reverb effect is reduced. That is, in a case in which an operation intensity of the key depression is low, the tone generator 5 can output a sound signal having a small sound image.

### [3] Third Embodiment

Next, an electronic musical apparatus 1 including a sound signal generation device 200 according to a third embodiment will be described. The configuration of the electronic musical apparatus 1 according to the third embodiment is similar to that of the first embodiment shown in FIGS. 1 and 2. In the third embodiment, the configuration of a sound image adjuster 52 is different from that of the first embodiment.

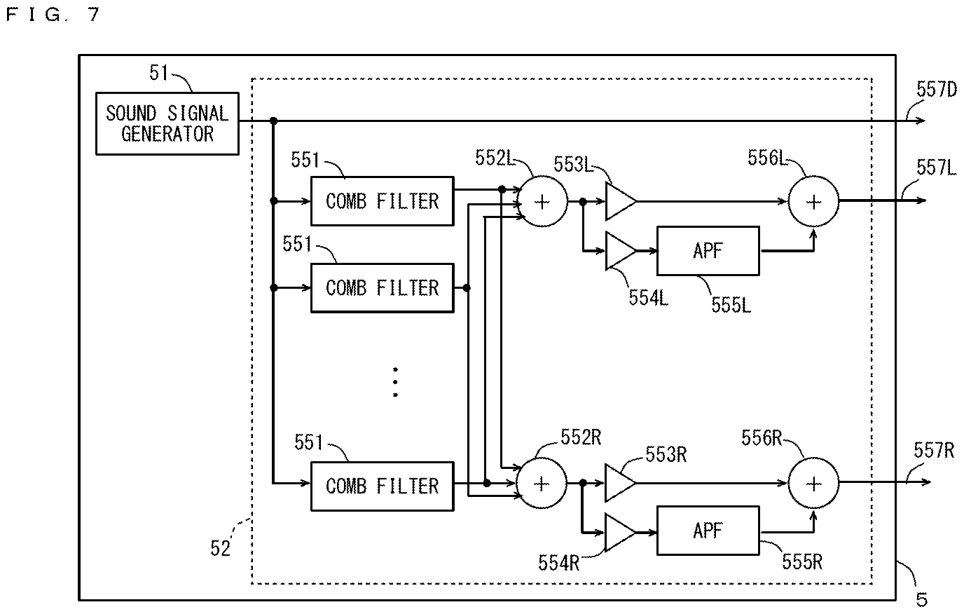

FIG. 7 is a diagram showing the configuration of a tone generator 5 according to the third embodiment. Similarly to the first embodiment, in the tone generator 5, a sound signal output from a sound signal generator 51 is processed in the sound image adjuster 52. The sound image adjuster 52 includes a plurality of comb filters 551, summing elements 552L, 552R, amplifying circuits 553L, 553R, amplifying circuits 554L, 554R, all pass filters (APF) 555L, 555R and summing elements 556L, 556R.

A sound signal output from the sound signal generator 51 is input to the plurality of comb filters 551. Similarly to the second embodiment, the combs filters 551 provide a reverb effect (reverberation effect) to the input sound signal.

Signals output from the comb filters 551 are respectively input to the summing elements 552L, 552R. The summing element 552L sums signals output from the respective comb filters 551 and outputs the sum of the sound signals to the amplifying circuit 553L and the amplifying circuit 554L. The summing element 552R sums signals output from the respective comb filters 551 and outputs the sum of the sound signals to the amplifying circuit 553R and the amplifying circuit 554R.

Signals output from the amplifying circuits 554L, 554R are respectively input to the all pass filters 555L, 555R. The all pass filters 555L, 555R are filters for changing the phases of input signals. The summing element 556L sums the output of the amplifying circuit 553L and the output of the all pass filter 555L. Output 557L of the summing element 556L is added to a direct sound signal (output 557D at the top of FIG. 7) output from the sound signal generator 51, and the sum is output to the sound system 6 as a left stereo signal. The summing element 556R sums the output of the amplifying circuit 553R and the output of the all pass filter 555R. The output 557R of the summing element 556L is added to the direct sound signal (the output 557D at the top of FIG. 7) output from the sound signal generator 51, and the sum is output to the sound system 6 as a right stereo signal.

Here, multiplication coefficients of the amplifying circuits 553L, 554L are controlled by a controller 100. The controller 100 adjusts the multiplication coefficients to be allocated to the amplifying circuits 553L, 554L in accordance with an operation intensity included in operation information. The controller 100 controls the amplifying circuits 553L, 554L such that the higher an operation intensity of key depression is, the larger the ratio of the multiplication coefficient of the amplifying circuit 554L with respect to the multiplication coefficient of the amplifying circuit 553L is.

Similarly, the controller 100 controls the amplifying circuits 553R, 554R such that the higher an operation intensity of key depression is, the larger the ratio of the multiplication coefficient of the amplifying circuit 554R with respect to the multiplication coefficient of the amplifying circuit 553R is.

Thus, the higher an operation intensity of key depression is, the larger the phase difference between the output 557L of the summing element 556L and the output 557R of the summing element 556R is, and the lower the correlation between the left and right sound signals is. Thus, a wide sound, that is, a sound signal having a large sound image is output from the tone generator 5. The lower an operation intensity of key depression is, the smaller the phase difference between the output 557L of the summing element 556L and the output 557R of the summing element 556R is, and the higher the correlation between the left and right sound signals is. Thus, a less wide sound, that is, a sound signal having a small sound image is output from the tone generator 5.

In this manner, the tone generator 5 according to the third embodiment adjusts the correlation between the left and right sound signals by controlling the phase difference between the left and right sound signals in accordance with an operation intensity included in operation information. That is, in a case in which an operation intensity of key depression is high, the tone generator 5 can output a sound signal having a large sound image. In a case in which an operation intensity of key depression is low, the tone generator 5 can output a sound signal having a small sound image.

### [4] Fourth Embodiment

Next, an electronic musical apparatus 1 including a sound signal generation device 200 according to a fourth embodiment of the present disclosure will be described. The configuration of the electronic musical apparatus 1 according to the fourth embodiment is similar to that of the first embodiment shown in FIGS. 1 and 2. In the fourth embodiment, the configuration of a sound image adjuster 52 is different from that of the first embodiment.

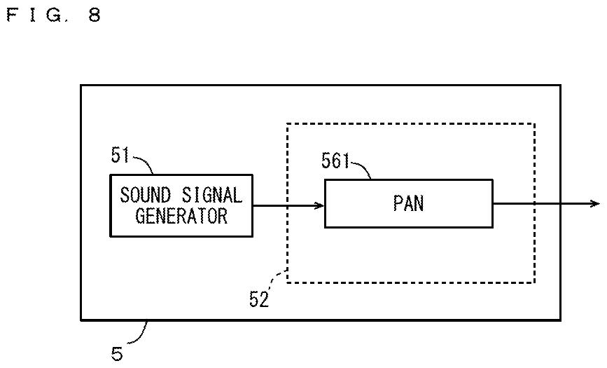

FIG. 8 is a diagram showing the configuration of a tone generator 5 according to the fourth embodiment. Similarly to the first embodiment, in the tone generator 5, a sound signal output from a sound signal generator 51 is processed in the sound image adjuster 52. The sound image adjuster 52 includes a panning circuit 561. The panning circuit 561 allocates a localization of a sound signal received from the sound signal generator 51 to the left and right. The panning circuit 561 is controlled by a controller 100. The controller 100 determines the left-right localization in the panning circuit 561 in accordance with an operation intensity included in operation information. The controller 100 controls left-right localization of a sound signal such that the higher an operation intensity of key depression is, the larger its variation range is. Thus, the higher an operation intensity of key depression is, the larger the variation range of left-right localization of a sound signal is, and the wider a sound is, that is, the larger a sound image of a sound signal to be output by the tone generator 5 is. The lower an operation intensity of key depression is, the smaller the variation range of the left-right localization of a sound signal is, and the less wide a sound is, that is, the smaller a sound image of a sound signal to be output by the tone generator 5 is.

### [5] Fifth Embodiment

Next, an electronic musical apparatus 1 including a sound signal generation device 200 according to a fifth embodiment of the present disclosure will be described. The configuration of the electronic musical apparatus 1 according to the fifth embodiment is similar to that of the first embodiment shown in FIG. 1. In each of the first to fourth embodiments, the sound image adjuster 52 is constituted by a hardware circuit and mounted on the tone generator 5. In the fifth embodiment, differently from the first to fourth embodiments, a sound image adjuster 102 is controlled by software and included in a controller 100.

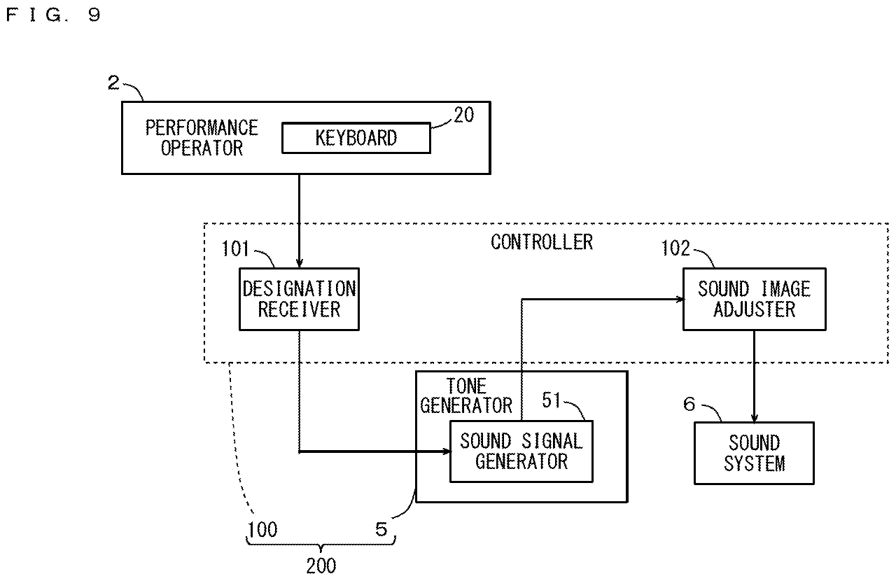

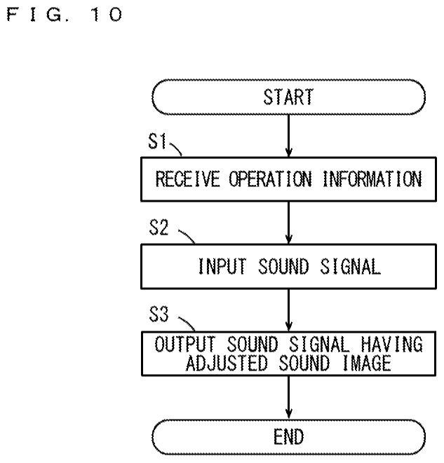

FIG. 9 is a block diagram showing the functional configuration of the sound signal generation device 200 and its peripheral devices according to the fifth embodiment. As shown in FIG. 9, the controller 100 includes a designation receiver 101 and a sound image adjuster 102. The designation receiver 101 and the sound image adjuster 102 are implemented when the CPU 8 of FIG. 1 executes the control program P1 stored in the storage device 7 or the ROM 11 while using the RAM 10 as a work area. The sound image adjuster 102 is a function obtained by simulation of the sound image adjuster 52 described in each of the first to fourth embodiments as a software process. With the fifth embodiment, similarly to each of the first to fourth embodiments, a sound signal having a sound image the size of which changes in accordance with an operation intensity of key depression can be generated.

FIG. 10 is a flowchart showing a sound signal generation method in the controller 100 of FIG. 9. The sound signal generation method of FIG. 10 is performed by execution of the control program P1 stored in the storage device 7 by the CPU 8 of FIG. 1. The control program P1 in the fifth embodiment is an example of a “sound signal generation program” of the present disclosure.

First, the designation receiver 101 receives operation information from the keyboard 20 (step S1). As described above, the operation information about a key includes information relating to a pitch, a note-on, a note-off and an operation intensity of a key. Next, the sound image adjuster 102 inputs a sound signal output from a sound signal generator 51 (step S2). Then, the sound image adjuster 102 outputs a sound signal having a sound image the size of which is adjusted in accordance with an operation intensity of a key (step S3). Specifically, in the step S3, the sound image adjuster 102 executes a process similarly to the sound image adjuster 52 in each of the first to fourth embodiments.

The control program P1 (sound signal generation program) may be supplied in the form of being stored in a computer readable recording medium and may be installed in the storage device 7 (or the ROM 11). Further, the control program P1 may be stored in an external storage device 13. Further, in a case in which the communication I/F 12 is connected to a communication network, the control program P1 delivered from a server connected to a communication network may be installed in the storage device 7 (or the ROM 11).

### [6] Effects of Second Embodiment to Fifth Embodiment

As described above, in the sound signal generation device 200 of each of the second to fourth embodiments, the tone generator 5 generates a sound signal corresponding to a pitch received by the designation receiver 101 such that the size of its sound image is in accordance with to an operation intensity received by the designation receiver 101. Further, in the sound signal generation device 200 of the fifth embodiment, the controller 100 generates a sound signal corresponding to a pitch received by the designation receiver 101 such that the size of its sound image is in accordance with an operation intensity received by the designation receiver 101. Thus, the sound signal generation device 200 of the present embodiment can generate a sound signal while changing a sound image in accordance with a received intensity similarly to an acoustic piano. Thus, the sound signal generation device 200 of the present embodiment can provide a performance feeling similar to that of an acoustic piano to a player.

### [7] Other Embodiments

In the above-mentioned embodiment, a sound image changes in accordance with an operation intensity received by the designation receiver 101. In another embodiment, the size of a sound image may further be changed in accordance with a pitch. For example, the higher a pitch is, the larger the size of a sound image is controlled to be.

Further, in another embodiment, a frequency transfer function (filter) may be changed in accordance with an operation intensity received by the designation receiver 101. Here, a frequency transfer function is a function for artificially converting a sound output from a speaker included in an electronic musical apparatus 1 into a sound generated from a tone generator located at a desired position. A sound signal generated in the tone generator 5 of the electronic musical apparatus 1 is processed by a frequency transfer function, so that a sound image changes.

Further, in the above-mentioned embodiment, a sound image of a sound signal is adjusted in the sound image adjuster 52. In another embodiment, a sound signal having an adjusted sound image may be added to an original signal (direct signal). Then, a sound image may be further changed by adjustment of the mixture ratio between the sound signal having an adjusted sound image and the original signal.

Further, in each of the above-mentioned second and third embodiments, the reverb effect (reverberation effect) is provided to a sound signal with use of a comb filter. In another embodiment, a filter may be divided into a minimum-phase component and an all-pass component, and the shape of an exponential window for respectively windowing the minimum-phase component and the all-pass component may change in accordance with an operation intensity. For example, the lower an operation intensity is, the sharper the shape of an exponential window is, and the higher an operation intensity is, the gentler the shape of an exponential window is.

### [8] Characteristics of Embodiments

The sound signal generation method, the sound signal generation device, the non-transitory computer readable recording medium storing the sound signal generation program, the electronic musical apparatus, an electronic musical instrument and the electronic keyboard instrument, described above, of the embodiments of the present disclosure have following characteristics.

A sound signal generation method according to one aspect of the present disclosure includes receiving a designation of a pitch and an intensity, and generating a sound signal corresponding to the pitch such that a size of a sound image of the sound signal is adjusted accordance with the intensity.

The sound signal is generated such that as the intensity increases a distribution of sound in a distance perspective increases.

The sound signal is generated by adjusting a correlation between left and right sound signals in accordance with the intensity.

The sound signal is generated by adjusting a panning of the sound signal in accordance with the intensity.

The size of the sound image may be adjusted in accordance with the pitch.

In the transmission network including the plurality of transmission circuits, a sound signal having a sound image the size of which is in accordance with a received intensity may be generated by receiving a sound signal, having the received pitch and intensity, in one node out of the plurality of nodes arranged in the transmission network, filtering of the sound signal when the sound signal is transmitted from the one node to another node, summation of sound signals received through respective transmission circuits in respective nodes and outputting the sum of the sound signals, and summation of sound signals output from respective nodes.

Adaptability of reverberation may be adjusted by adjustment of the number of enabled comb filters in accordance with a received intensity. Then, a sound signal having a sound image the size of which is in accordance with a received intensity may be generated.

A sound signal generation device according to another aspect of the present disclosure includes a designation receiver that receives a designation of a pitch and an intensity, and a tone generator that generates a sound signal corresponding to the pitch such that a size of a sound image of the sound signal is adjusted in accordance with the intensity.

A computer product comprising a non-transitory computer readable medium having stored thereon program code which, when executed by a processor, carries out acts of receiving a designation of a pitch and an intensity, and generating a sound signal corresponding to the pitch such that a size of a sound image of the sound signal is adjusted in accordance with the intensity.

An electronic musical apparatus according to yet another aspect of the present disclosure includes the above-mentioned sound signal generation device, and an outputter that outputs the sound signal generated by the sound signal generation device.

An electronic musical instrument according to yet another aspect of the present disclosure includes the above-mentioned sound signal generation device, a performance operator that supplies information in regard to the pitch and the intensity to the designation receiver, and an outputter that outputs the sound signal generated by the sound signal generation device.

An electronic keyboard musical instrument according to yet another aspect of the present disclosure includes the above-mentioned sound signal generation device, a performance operator comprising a keyboard for supplying information in regard to the pitch and the intensity to the designation receiver, and an outputter that outputs the sound signal generated by the sound signal generation device.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

1. A sound signal generation method comprising:
receiving a pitch and an intensity; and
generating a sound signal corresponding to the pitch such that a size of a sound image of the sound signal is adjusted in accordance with the intensity.

2. The sound signal generation method according to claim 1, wherein
the sound signal is generated such that as the intensity increases, a distribution of sound in a distance perspective increases.

3. The sound signal generation method according to claim 1, wherein
the sound signal is generated by adjusting a correlation between left and right sound signals in accordance with the intensity.

4. The sound signal generation method according to claim 1, wherein
the sound signal is generated by adjusting a panning of the sound signal in accordance with the intensity.

5. The sound signal generation method according to claim 1, wherein
the size of the sound image is adjusted in accordance with the pitch.

6. A sound signal generation device comprising:
a designation receiver that receives a pitch and an intensity; and
a tone generator that generates a sound signal corresponding to the pitch such that a size of a sound image of the sound signal is adjusted in accordance with the intensity.

7. A computer product comprising a non-transitory computer readable medium having stored thereon program code which, when executed by a processor, carries out acts of:
receiving a pitch and an intensity; and
generating a sound signal corresponding to the pitch such that a size of a sound image of the sound signal is adjusted in accordance with the intensity.

8. An electronic musical apparatus comprising:
the sound signal generation device according to claim 6; and
an outputter that outputs the sound signal generated by the sound signal generation device.

9. An electronic musical instrument comprising:
the sound signal generation device according to claim 6;
a performance operator that supplies information in regard to the pitch and the intensity to the designation receiver; and
an outputter that outputs the sound signal generated by the sound signal generation device.

10. An electronic keyboard musical instrument comprising:
the sound signal generation device according to claim 6;
a performance operator comprising a keyboard for supplying information in regard to the pitch and the intensity to the designation receiver; and
an outputter that outputs the sound signal generated by the sound signal generation device.
